(19) United States
(12) Patent Application Publication
(10) Pub. No.: US 2020/0329195 A1
(43) Pub. Date: Oct. 15, 2020

(54) SYNCHRONIZING APPLICATION OF SETTINGS FOR ONE OR MORE CAMERAS

(71) Applicant: Qualcomm Incorporated, San Diego, CA (US)

(72) Inventors: Jeyaprakash Soundrapandian, San Diego, CA (US); Viswanadha Raju Thotakura, San Jose, CA (US); Karthik Anantha Ram, La Jolla, CA (US)

(21) Appl. No.: 16/657,159

(22) Filed: Oct. 18, 2019

Related U.S. Application Data
(60) Provisional application No. 62/832,721, filed on Apr. 11, 2019.

(51) Int. Cl. H04N 5/232; H04N 5/235

(52) U.S. Cl. CPC H04N 5/23227; H04N 5/2353; H04N 5/23225

(57) ABSTRACT

Synchronization of settings for different camera components are described. An example device may include a memory and one or more processors coupled to the memory. The one or more processors may be configured to instruct, at a first time, application of a first setting corresponding to a first camera component. Application of the first setting may be associated with a first delay. The one or more processors may also be configured to determine, based on the first delay, a second time to instruct application of a second setting corresponding to a second camera component. The one or more processors may further be configured to instruct, at the second time, application of the second setting. Application of the first setting and application of the second setting are synchronized based on the first time and the second time.

### RELATED APPLICATION

This application claims priority to U.S. Provisional Patent Application No. 62/832,721, titled “SYNCHRONIZATION OF APPLYING SETTINGS FOR ONE OR MORE CAMERAS,” filed Apr. 11, 2019, which is hereby incorporated by reference in its entirety.

### TECHNICAL FIELD

This disclosure relates generally to digital cameras, and aspects of the present disclosure relate to synchronizing application of capture and/or processing settings for one or more cameras.

### BACKGROUND

Many devices and systems (such as smartphones, tablets, digital cameras, security systems, computers, and so on) include or are coupled to one or more cameras for capturing images and/or video. Multiple settings may be applied for the one or more cameras (including settings corresponding to a camera sensor, a flash, an image signal processor (ISP), an imaging front end (IFE), a lens actuator, or other components for capturing and processing images). For example, a smartphone may adjust a position of a camera lens, an exposure duration of a camera sensor, a gain of a signal from the camera sensor before analog-to-digital conversion (ADC), one or more white balance settings for performing automatic white balance (AWB) by the ISP, other image quality (IQ) settings for the ISP, the intensity and duration of a flash, etc.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

Aspects of the present disclosure relate to synchronizing the application of settings for different camera components. In some implementations, an example device may include a memory and one or more processors coupled to the memory. The one or more processors may be configured to instruct, at a first time, application of a first setting corresponding to a first camera component. Application of the first setting may be associated with a first delay. The one or more processors may also be configured to determine, based on the first delay, a second time to instruct application of a second setting corresponding to a second camera component. The one or more processors may further be configured to instruct, at the second time, application of the second setting. Application of the first setting and application of the second setting are synchronized based on the first time and the second time.

An example method may include instructing, at a first time, application of a first setting corresponding to a first camera component. Application of the first setting may be associated with a first delay. The example method may also include determining, based on the first delay, a second time to instruct application of a second setting corresponding to a second camera component. The example method may further include instructing, at the second time, application of the second setting. Application of the first setting and application of the second setting may be synchronized based on the first time and the second time.

An example non-transitory, computer readable medium may store instructions that, when executed by one or more processors of a device, cause the device to instruct, at a first time, application of a first setting corresponding to a first camera component. Application of the first setting may be associated with a first delay. Execution of the instructions may further cause the device to determine, based on the first delay, a second time to instruct application of a second setting corresponding to a second camera component. Execution of the instructions may also cause the device to instruct, at the second time, application of the second setting. Application of the first setting and application of the second setting may be synchronized based on the first time and the second time.

An example device may include means for instructing, at a first time, application of a first setting corresponding to a first camera component. Application of the first setting may be associated with a first delay. The example device may also include means for determining, based on the first delay, a second time to instruct application of a second setting corresponding to a second camera component. The example device may further include means for instructing, at the second time, application of the second setting. Application of the first setting and application of the second setting may be synchronized based on the first time and the second time.

### BRIEF DESCRIPTION OF THE DRAWINGS

Aspects of this disclosure are illustrated by way of example, and not by way of limitation, in the figures of the accompanying drawings and in which like reference numerals refer to similar elements.

FIG. 1 is an illustration of an example timing diagram of instruction and application of settings for multiple camera components.

FIG. 2 is a block diagram of an example device.

FIG. 3 is an illustration of a camera request manager coupled to a plurality of camera components for a single camera.

FIG. 4 is an illustration of a camera request manager coupled to a plurality of camera components for two cameras.

FIG. 5 is an illustrative flow chart depicting an example process for coordinating instruction of applying settings for multiple camera components.

FIG. 6 is an illustrative flow chart depicting an example process for coordinating instruction of applying settings for multiple camera components from the same imaging pipeline.

FIG. 7 is an illustrative flow chart depicting an example process for coordinating instruction of applying settings for multiple camera components from different imaging pipelines.

FIG. 8 is an illustration of an example timing diagram of error handling by a camera request manager.

FIG. 9 is an illustrative flow chart depicting error handling in coordinating instruction of applying settings for multiple camera components in different imaging pipelines.

### DETAILED DESCRIPTION

Aspects of the present disclosure relates generally to image capture and processing, and for example, to synchronizing application of capture and/or processing settings corresponding to multiple camera components. A device or system may be coupled to or include one or more camera sensors, camera lens actuators, gain and sampling components or other IFE components, ISPs, light sources, or other components of an imaging pipeline. An imaging pipeline (as used herein) may refer to components configured for capturing and/or for processing an image. For example, the imaging pipeline may include an image capture pipeline for capturing an image frame. Components of the image capture pipeline may include a flash, an image sensor, a camera lens actuator, etc. The imaging pipeline may also include an image processing pipeline for processing the captured image frame. Components of the image processing pipeline may include an IFE, an ISP, one or more filters outside the ISP, etc. A camera component (as used herein) may refer to a component anywhere in the imaging pipeline, such as from the image capture pipeline and/or the image processing pipeline. For example, a camera may include one or more of the following camera components: a camera sensor; a camera lens; a lens actuator; an imaging front end; or a flash. A device may also include one or more camera components outside of a camera, such as one or more filters of an image signal processor.

A camera component may be associated with one or more settings that are applied before image capture or processing. For example, a camera lens may be associated with a focal length setting, a camera sensor may be associated with an exposure duration setting or sensitivity setting, a flash may be associated with a flash duration setting or a flash type setting (such as a strobe flash or a continuous lighting), an IFE may be associated with a gain setting for ADC, and an ISP may be associated with one or more filter settings (such as a white balance setting, denoising setting, edge enhancement setting, color correction setting, etc.). Other settings and camera components may exist, and the list of camera components and settings are for illustrative purposes. However, multiple settings may be instructed for different camera components in the imaging pipeline.

A device may instruct that settings be applied for one or more of the components in the imaging pipeline. In one example, the device may instruct a camera lens actuator to adjust the position of a camera lens (e.g., to adjust the focal length of a camera). In another example, the device may instruct a camera sensor's controller to adjust one or more of a frame rate, an exposure duration during a frame (shutter speed), or an exposure sensitivity of the camera sensor. In a further example, the device may instruct an IFE to increase the gain of the currents from the camera sensor (representing different pixel values of a captured frame) before ADC. In another example, the device may instruct an ISP to perform a specific denoising process (or other process associated with other filters of the ISP). In a further example, the device may instruct the ISP as to which filters are to be performed and which filters are not to be performed.

A delay exists between instructing a camera component setting be applied and the setting being applied. For example, an amount of time passes between a device instructing a camera lens actuator to adjust the position of the camera lens and the camera lens actuator moving the camera lens to the adjusted position. The delay may differ between settings for different camera components. For example, the delay associated with adjusting the camera lens position may differ from the delay associated with adjusting the camera sensor's shutter speed. In some instances, different camera components in the imaging pipeline may be provided by different manufacturers, and different manufacturers may have different delays associated with the manufacturer's camera components. For example, a camera sensor may be from one manufacturer while portions of the IFE are from another manufacturer. As a result, a delay associated with applying a setting for the camera sensor may be different that a delay associated with applying a setting for the IFE.

The delays to implement settings for different camera components may be significant enough that one setting may be applied before a start of a frame and another setting may be applied after the start of the frame. In some instances, the delay to apply settings for two different camera components may be greater than the frame length of a camera stream (which may also be referred to as a frame period). If a camera is configured to capture 30 frames per second (fps), a frame capture may occur approximately every 33 milliseconds (and the frame length approximately equals 33 milliseconds). In one example, the delay to apply the camera sensor's exposure setting and the delay to apply the gain setting in the IFE may be greater than 33 milliseconds. As a result, if application of settings are instructed at the same time, the settings may be applied for different frames of the camera stream as a result of the difference in delay. In this manner, a final image may be captured and processed based on a frame from the camera stream with an incomplete group of settings applied, which may provide an unwanted image or otherwise interfere with the user experience.

Additionally, some devices include or are coupled to multiple cameras (such as dual camera systems or triple camera systems), and the delay for applying settings may differ between the same or different type of camera components between cameras. For example, two cameras may include camera sensors with different numbers of pixels, different pixel sizes, and so on, as compared to each other. As a result, the cameras may correspond to different delays in applying settings for their respective camera sensor or IFE. As a result, if application of settings for camera components of different cameras are instructed at the same time, the settings may be applied for frames of the different camera streams that are separated in time as a result of the difference in delay. In this manner, the final images may be captured and processed based on frames from the camera streams without the settings being applied to the camera components for both camera streams, which may cause inconsistencies between the corresponding images.

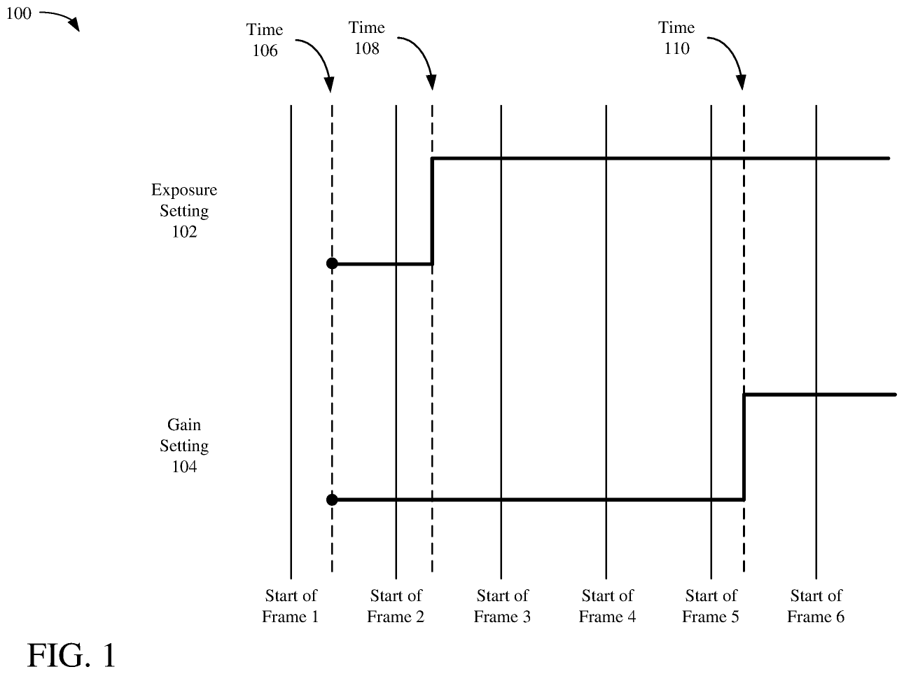

FIG. 1 is an illustration of an example timing diagram 100 for instructing and applying an exposure setting 102 for a camera sensor and instructing and applying a gain setting 104 for an IFE. The timing is illustrated with reference to start of frame capture, with the vertical lines indicating start of frames (SOF) 1, 2, and so on, and the space between neighboring vertical lines indicating the time between SOFs (such as the frame period or length). In the example, applying the exposure setting 102 has a delay associated with approximately one frame period, and applying the gain setting 104 has a delay associated with approximately four frame periods. If both settings 102 and 104 are instructed at time 106, the exposure setting 102 may be applied at time 108, and the gain setting 104 may be applied at time 110. The first frame capture with both settings 102 and 104 applied begins at SOF 6. As a result, SOFs 3-5 correspond to the exposure setting 102 being applied and the gain setting 104 not being applied. Any output frames associated with SOFs 3-5 may not have the correct gain setting 104 and therefore may not be desirable. A device may compensate for the incorrect gain setting 104 through post-capture processing, but processing the image (such as adjusting the brightness) may cause additional noise or artifacts in an image, introduce latencies in providing an output image after capture, or otherwise impact a user experience.

A device may also compensate for incomplete application of settings by disregarding intermediate frames until all settings are applied. For example, a device may not use any output frames corresponding to SOFs 3-5. However, multiple settings may be queued to be applied in a specific sequence for one or more camera components. If a queued plurality of settings are to be applied in a specific order for different camera components (for a single or multiple camera system), the delays in applying the settings may aggregate over the sequence of settings to be applied. As a result, a significant number of frames in the camera stream may be associated with an incomplete group of settings applied. If a device disregards frames until all settings of a group of settings are applied, the device may disregard a significant number of frames, which may cause latency during image capture and processing or otherwise impact image capture and processing using the camera stream.

As described above, post-processing or preventing use of intermediate frames captured with misaligned settings 102 and 104 (associated with a camera sensor and an IFE, respectively) may negatively impact a user experience. Such negative impact may also occur for applying settings for other camera components. In some instances, multiple cameras may be used to concurrently capture multiple frames that are combined for an image (such as a stereoscopic image, a depth-based image, and so on). If the camera sensors of the multiple cameras are associated with different delays, an exposure setting may be applied for a first camera sensor while a corresponding exposure setting for a second camera sensor is not applied before a SOF of the two camera streams. As a result, an overall luminance of a frame corresponding to the SOF from the second camera sensor's camera stream may differ from an overall luminance of a frame corresponding to the SOF the first camera sensor's camera stream. The difference in luminance between the frames may be undesirable, and the quality of a resulting image corresponding to frames from different camera streams with different exposure settings applied may be reduced. As noted above, disregarding frames or post-processing frames to correct artifacts caused by differences in applied settings may introduce latency or otherwise negatively impact a user experience. For example, latency sensitive applications, such as virtual reality (VR) or augmented reality (AR) applications, may be negatively impacted by delays in outputting images for viewing or otherwise disrupting a stream of images of a video for VR or AR.

In some implementations, a device may time instructing application of settings for different camera components to synchronize application of the settings. For example, the device may instruct, at a first time, the application of a first setting and may instruct, at a second time, the application of a second setting. The difference in the first time and the second time may compensate for a difference in delay in applying the first setting and delay in applying the second setting. In this manner, application of settings for different camera components associated with different delays may be applied at similar times. As a result, the number of frames of a camera stream with all settings applied may be increased by timing instruction of applying the settings. If disregarding frames or post-processing frames (as noted above) is also performed, the number of frames disregarded as a result of unapplied settings may be reduced, or post-processing of frames as a result of unapplied settings may be reduced, thus improving a user experience.

In the following description, numerous specific details are set forth such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure. Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

Aspects of the present disclosure are applicable to any suitable processor (such as an application processor or image signal processor) or device or system (such as smartphones, tablets, laptop computers, digital cameras, web cameras, security systems, and so on) that include one or more cameras, and may be implemented for a variety of camera configurations. While portions of the below description and examples use one or two cameras to describe aspects of the disclosure, the disclosure applies to any device or system with one or more cameras (such as three cameras). The disclosure may also apply to a device or system with no cameras but is configured to instruct application of settings for camera components of one or more imagining pipelines. The cameras may have similar or different capabilities (such as resolution, color or black and white, a wide view lens versus a telephoto lens, zoom capabilities, and so on).

The term “device” is not limited to one or a specific number of physical objects (such as one smartphone, one controller, one processing system and so on). As used herein, a device may be any electronic device with one or more parts that may implement at least some portion of this disclosure. While the below description and examples use the term “device” to describe various aspects of this disclosure, the term “device” is not limited to a specific configuration, type, or number of objects. For example, a device may be a user device (such as a smartphone, tablet, security camera, computer, etc.) or any portion of components of a user device (such as a system-on-chip (SoC), a board and components attached to the board (or portion thereof), etc.). Additionally, the term “system” is not limited to multiple components or specific embodiments. For example, a system may be implemented on one or more printed circuit boards or other substrates, have one or more housings, be one or more objects integrated into another device, and may have movable or static components. While the below description and examples may use the terms “device” or “system” to describe various aspects of this disclosure, the terms “device” and “system” are not limited to a specific configuration, type, or number of objects or components.

As noted above, the term “camera component” may be any component within the imaging pipeline for capture and processing of an image. A camera component may be part of or outside of a camera module. For example, camera components may include a camera sensor, an IFE for the camera sensor, a lens actuator, a light source/flash, an ISP, or other portions of a camera controller which may be external to the camera module. Additionally, some camera components (such as the ISP) may be configured to perform operations outside of the imaging pipeline. Therefore, the term “camera component” is not to be interpreted as limiting the components to within or specific to a camera module.

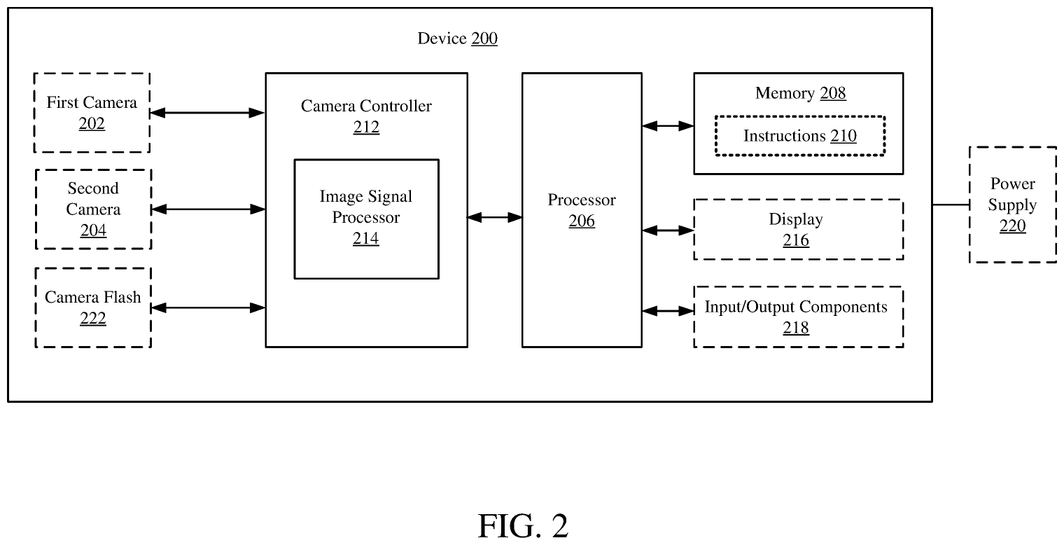

FIG. 2 is a block diagram of an example device 200 including one or more cameras. The example device 200 may be any suitable device configured to instruct application of settings for one or more camera components. The example device 200 may include a processor 206, a memory 208 storing instructions 210, and a camera controller 212. In some implementations, the device 200 may include a first camera 202 (e.g., a user device including an integrated camera). In some other implementations, the device 200 may be coupled to the first camera 202 (e.g., a processing SoC may be coupled to a camera module). The device 200 may optionally include or be coupled to a second camera 204, a camera flash system 222, a display 216, and a number of input/output (I/O) components 218. In some implementations, the device 200 may include additional features or components not shown. For example, a wireless interface, which may include a number of transceivers and a baseband processor, may be included for a wireless communication device.

The first camera 202 and the second camera 204 may include one or more camera sensors (not shown for simplicity), shutters, camera lens actuators, sampling and signal amplification components, and other IFE components for providing images captured by the camera sensors to the camera controller 212. The first camera 202 and the second camera 204 may provide the captured images to the camera controller 212, which may include some components of the IFE. In some example implementations, the first camera 202 and the second camera 204 may be part of a multiple (e.g., dual) camera module included or coupled to the device 200. For example, the first camera 202 may be a primary camera, and the second camera 204 may be an auxiliary camera. The capabilities and characteristics of the first camera 202 and the second camera 204 (such as the focal length, field of view, resolution, color palette, color vs monochrome, etc.) may be the same or different. In some other implementations, the device 200 includes or is coupled to a single camera system and does not include the second camera 204.

The memory 208 may be a non-transient or non-transitory computer readable medium storing computer-executable instructions 210 to perform all or a portion of one or more operations described in this disclosure. In some implementations, the device 200 may include a power supply 220. In some other implementations, the power supply 220 may be coupled to the device 200.

The processor 206 may be one or more suitable processors capable of executing scripts or instructions of one or more software programs (such as instructions 210) stored within the memory 208. In some aspects, the processor 206 may be one or more general purpose processors that execute instructions 210 to cause the device 200 to perform any number of different functions or operations. For example, the processor 206 may be an applications processor to execute applications stored in memory 208.

In additional or alternative aspects, the processor 206 may include integrated circuits or other hardware to perform functions or operations without the use of software. While shown to be coupled to each other via the processor 206 in the example device 200, the processor 206, memory 208, camera controller 212, the optional display 216, and the optional I/O components 218 may be coupled to one another in various arrangements. For example, the processor 206, the memory 208, the camera controller 212, the display 216, and/or the I/O components 218 may be coupled to each other via one or more local buses (not shown for simplicity).

In some implementations, the device 200 includes a display 216. The display 216 may be any suitable display or screen allowing for user interaction and/or to present items (such as captured images and video) for viewing by a user. In some aspects, the display 216 may be a touch-sensitive display. In some implementations, the device 200 may include one or more I/O components. The I/O components 218 may be or include any suitable mechanism, interface, or device to receive input (such as commands) from the user and to provide output to the user. For example, the I/O components 218 may include (but are not limited to) a graphical user interface, keyboard, mouse, microphone and speakers, etc.

The camera controller 212 may include an image signal processor 214, which may be one or more image signal processors, to process captured image frames provided by the first camera 202 and the optional second camera 204. In some implementations, the camera controller 212 (such as by using the image signal processor 214) may control operation of the first camera 202 and the optional second camera 204. The camera controller 212 may also be configured to control the optional camera flash 222. In some implementations, the image signal processor 214 may execute instructions from a memory (such as instructions 210 from the memory 208 or instructions stored in a separate memory coupled to the image signal processor 214), or instructions from the processor 206, to control operation of the cameras 202 and 204 and/or to process one or more images from the cameras 202 and 204. For example, the image signal processor 214 may convert general instructions from the processor 206 to module or component specific instructions to be provided to, e.g., the first camera 202, the second camera 204, and/or the camera flash 222. In some other implementations, the image signal processor 214 may include specific hardware to control operation of the cameras 202 and 204 and/or to process one or more images from the cameras 202 and 204. In some further implementations, the image signal processor 214 may include a combination of hardware and the ability to execute software instructions.

While the device 200 in FIG. 2 is referred to in describing aspects of the disclosure, any suitable device may be used. For example, the device is not required to include all of the modules or the specific configuration of modules shown in FIG. 2. In some implementations, the device may be a processing system configured to instruct settings be applied for one or more camera components. In some other implementations, the device may be a user device (such as a smartphone, digital camera, security hub or system, etc.).

The device 200 may use a camera request manager (CRM) to schedule when different settings are to be instructed to be applied for camera components. In this manner, the device may use the CRM to schedule instructions so that application of the corresponding settings are completed during the same frame (before a same SOF for the next frame in the camera stream). At the scheduled time, the device 200 may provide the instruction to the component responsible for applying the setting. For example, for an exposure setting, the device 200 may instruct a camera sensor controller of the first camera 202 to adjust the camera sensor's exposure.

For a plurality of settings to be applied in sequence, a delay corresponding to each instruction (and associated setting) may differ enough that a setting subsequent to a first setting may be applied before applying the first setting is complete. In some implementations, the CRM may be configured for out of order instruction of queued requests to apply settings. In this manner, the CRM may change the order instructions are provided to components to ensure the order that the settings are applied conform to the sequence.

In some implementations, the CRM may be a driver stored as executable code in the memory 208 (such as part of instructions 210) and executed by the processor 206. The processor 206, in executing the CRM driver, is configured to schedule or adjust when requests for applying settings are to be instructed to the specific camera components. In some implementations, the processor 206 may be an application processor executing the CRM driver retrieved from the memory 208. The CRM driver, when executed by the processor 206, may cause the processor 206 to provide, to the camera controller 212, one or more non-component specific instructions to apply multiple settings by the different camera components.

The camera controller 212 (such as the image signal processor 214) may be configured to convert each general instruction for applying a setting to a component specific instruction. For example, each manufacturer may have a format for instructions differing from other manufacturers. In this manner, each general instruction from the processor 206 may be converted to a specific instruction format (such as based on the manufacturer). The camera controller 212 may also be configured to provide the component specific instruction to the component responsible for applying the setting.

For example, the device 200 may receive a user input to adjust an exposure of the first camera 202, or the device 200, in performing an automatic exposure process, may determine to adjust the exposure of the first camera 202. The processor 206 (in executing the CRM) may provide, to the camera controller 212, a general instruction to adjust an exposure of the camera sensor of the first camera 202 (e.g., changing the shutter speed or the sensitivity of the camera sensor). The image signal processor 214 may convert the general instruction to an instruction specific to the camera sensor. The camera controller 212 may then provide the component specific instruction to the camera sensor controller of the first camera 202 in order for the controller to adjust the exposure of the camera sensor.

As noted above, multiple settings may be applied for the same frame, or a sequence of settings may be applied in order. The device 200 may be configured to synchronize application of settings or the order of application of settings. For example, the device 200 may schedule when to provide instructions to camera components to apply settings in order to compensate for delays in applying the settings after instructing (such as to synchronize applying multiple instructions or to ensure instructions are applied in a specific order). In some implementations, the camera controller 212 may coordinate instructing camera components (using component specific instructions) to apply settings for the same frame of one or more camera streams or in a specific order. The coordination may be based on an indication, from the processor 206, associated with instructing application of a setting for a camera component or applying a setting for the camera component. In some implementations, the processor 206 may provide a time stamp or other time indication to the camera controller 212 as to when a specific instruction (e.g., an instruction generated for a specific camera component by the image signal processor 214) is to be provided to the corresponding camera components. In some other implementations, the processor 206 may provide a time stamp or other time indication (such as a frame identifier) to the camera controller 212 as to when the settings are to be applied. In some other implementations, the processor 206 may coordinate when to provide general instructions to the camera controller 212, considering, e.g., the time to convert general instructions to component specific instructions, providing the component specific instructions to the corresponding components, and applying the settings based on the specific instructions. In this manner, application of settings may be synchronized while the camera controller 212 still provides component specific instructions as soon as ready (without requiring timing of the instructions at the camera controller 212).

While the CRM is described above as software that may be executed to cause a device to perform operations, in some other implementations, the CRM may include dedicated hardware. For example, the CRM may include one or more circuits within the processor 206, within the camera controller 212, within other components of the device 200, or as a separate module of the device 200. In some further implementations, the CRM may include a combination of hardware and software, and the functions of the CRM may be performed by one or multiple modules of the device 200.

In the following examples, the CRM is described as performing processes in explaining aspects of the disclosure. Referring to the CRM performing a process may refer to one or more hardware modules performing the process, a processor executing software of the CRM causing one or more device modules to perform the process, or a combination of the above. As such, the present disclosure is not limited to a specific implementation of the CRM.

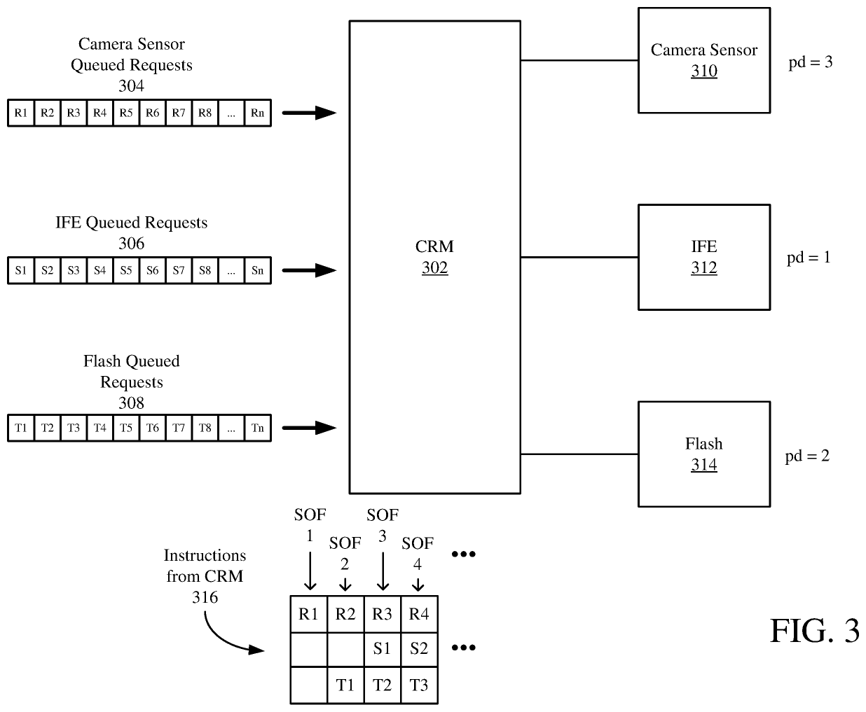

FIG. 3 is an illustration of a CRM 302 coupled to a plurality of camera components 310-314 for a single camera. In one example, the CRM 302 may be instructions executed by the processor 206 (FIG. 2), and the processor 206 may be coupled to the plurality of camera components 310-314. In another example, hardware associated with the CRM may be coupled to the plurality of camera components 310-314. As used herein, “coupling” may refer to a physical coupling that may be direct or indirect (such as the processor 206 physically coupled to the camera controller 212 directly or via a bus, and the processor 206 physically coupled to the camera 202 via the camera controller 212). Coupling may otherwise refer to a communicative coupling that may not require a physical coupling (such as wireless communication devices are communicatively coupled without being physically coupled).

As illustrated in FIG. 3, the CRM 302 is coupled to a camera sensor 310, the CRM 302 is coupled to an IFE 312 (which may include at least a portion of a first camera 202 or a second camera 204 up to the camera controller 212), and the CRM 302 is coupled to a flash 314. Each camera component 310-314 is associated with a delay between instructing a setting be applied and the setting being applied for the corresponding camera component 310-314. The delay is depicted as a pipeline delay (pd) which indicates the length of the delay in terms of number of frames or frame periods. In the example, the camera sensor 310 is associated with a pd of three frame periods (pd=3), the IFE 312 is associated with a pd of one frame period (pd=1), and the flash 314 is associated with a pd of two frame periods (pd=2).

The CRM 302 may be configured to receive queued requests for settings to be applied for the camera components 310-314. For example, the CRM 302 may receive camera sensor queued requests 304, IFE queued requests 306, and flash queued requests 308 to apply one or more settings for the corresponding component 310-314. In the example, the camera sensor queued requests 304 include requests R1-Rn, the IFE queued requests 306 include requests S1-Sn, and the flash queued requests 308 include requests T1-Tn. Any number of requests may exist for each queue (including none), and the illustrated example is to assist in describing aspects of the disclosure.

In some implementations, one or more applications (such as a camera application) may be executed by the processor 206 (FIG. 2). For example, a smartphone may launch a camera application in response to receiving a user input of pressing a camera icon on the display 216. The camera application may then generate requests for different settings to be applied in response to, e.g., auto-exposure or auto-focus processes during initialization, a user input to adjust a camera or processing feature, the application determining one or more adjustments to be made in response to processing the camera stream, etc. The processor 206, in executing the one or more applications, may sort the requests based on the settings to be applied or the camera components associated with the settings, and the processor 206 may queue the sorted requests for the CRM 306 (such as illustrated in FIG. 3). In some other implementations, the requests may be provided to the CRM 306 when available, and the CRM 306 may manage buffering, queueing or any other suitable intake process for the requests from the one or more applications.

In some implementations, application of settings for requests R1-Rn, application of settings for requests S1-Sn, and application of settings for requests T1-Tn may be completed in the order queued or received. Furthermore, application of one or more settings for request R1 for the camera sensor 310, application of one or more settings for request S1 for the IFE 312, and application of one or more settings for request T1 for the flash 314 are to be completed for the same frame capture (such as before a SOF of a first frame). Requests R2, S2, and T2 similarly may be associated with settings to be applied for a same frame capture (such as a SOF of a second frame after the first frame). Requests R3, S3, and T3, requests R4, S4, and T4, and so on may similarly be associated with settings that are to have synchronized application for one frame.

To compensate for different delays for the components 310-314, the CRM 302 may be configured to coordinate sending instructions for application of the settings for the camera components 310-314, as illustrated by the instruction sequence 316. In some implementations, the CRM 302 may be configured to send, at the SOFs in the camera stream for the camera, instructions associated with the requests for applying settings to the components 310-314. In this manner, the CRM 302 may provide an instruction associated with R1 at SOF 1, and the CRM 302 may provide an instruction associated with R2 and an instruction associated with T1 at SOF 2. The CRM 302 may then provide an instruction associated with R3, an instruction associated with T2, and an instruction associated with Si at SOF 3. The CRM 304 may further provide an instruction associated with R4, an instruction associated with T3, and an instruction associated with S2 at SOF 4, and so on. While the instructions in the instruction sequence 316 for the requests are described as being provided each SOF, any suitable timing for providing the instructions may be used (such as a SOF every multiple of frame periods (such as each SOF every other frame period), at a time during the frame period other than the SOF, periodically during a frame period, and so on). In some implementations, the timing of providing instructions may differ based on the associated requests or a current operation of the device 200 (such as whether the device 200 is in a power save mode, a high-power mode, whether a camera application executed by the processor 206 is a foreground process or a background process, and so on).

Since the camera sensor 310 is associated with a pd of three, application of the setting for request R1 may be completed by SOF 4 (after a three frame delay), application of the setting for request R2 may be completed by SOF 5, and so on. Since the IFE 312 is associated with a pd of one, application of the setting for request S1 may be completed by SOF 4 (since instructed at SOF 3 and having a one frame delay), application of the setting for request S2 may be completed by SOF 5, and so on. Since the flash 314 is associated with a pd of two, application of the setting for request T1 may be completed by SOF 4 (since instructed at SOF 2 and having a two frame delay), application of the setting for request T2 may be completed by SOF 5, and so on. In this manner, application of settings for requests R1, S1, and T1 are completed by SOF 4. As noted above, example settings may include exposure for the camera sensor 310, gain for the IFE 312, and intensity or duration for the flash 314. Other settings or camera components may be included and are not limited to the provided example. For example, other camera components may be coupled to the CRM 302, such as a lens actuator, portions of the image signal processor 214 for processing frame captures, etc., associated with different settings for application.

In some implementations, the delay (such as the pd) may be provided by the component manufacturer or may otherwise be provided before operation of the camera component. In some other implementations, the device 200 may determine a pd for one or more camera components (such as during startup of the device 200 or during a calibration of one or more camera components). The CRM 302 may include associations or a mapping of delays to camera components to coordinate providing instructions by the CRM 302. The mapping may be created or adjusted based on the information from the component manufacturer(s) or the determined delays (such as during startup or calibration).

As used herein, a delay being associated with a camera component may refer to the delay in applying a setting after instruction for the camera component. The delay associated with a camera component may be static or dynamic. For example, some components may have a dynamic pd that is based on a camera mode, current use of the camera or components of the imaging pipeline, or other factors. For example, the pd for the flash 314 may be based on an intensity of the flash 314 to be provided (such as if the flash 314 requires charging, with the time to charge corresponding to the intensity), and the intensity may be based on whether a still image or a video is to be recorded. In another example, a pd associated with a color correction filter of the image signal processor 214 may be based on the resolution of the image to be processed. In some implementations, the CRM 302 is configured to adjust when instructions are to be provided based on the current pd associated with the camera component. For example, the mapping of pd to camera components may be adjusted based on a camera mode or current use of camera components. In this manner, the CRM 302 may be configured to account for different states or modes of the components, including different capture and/or processing parameters for the camera and ISP (such as different resolutions, frame rates, shutter speeds, color balance, etc.) or other factors that may impact the pd.

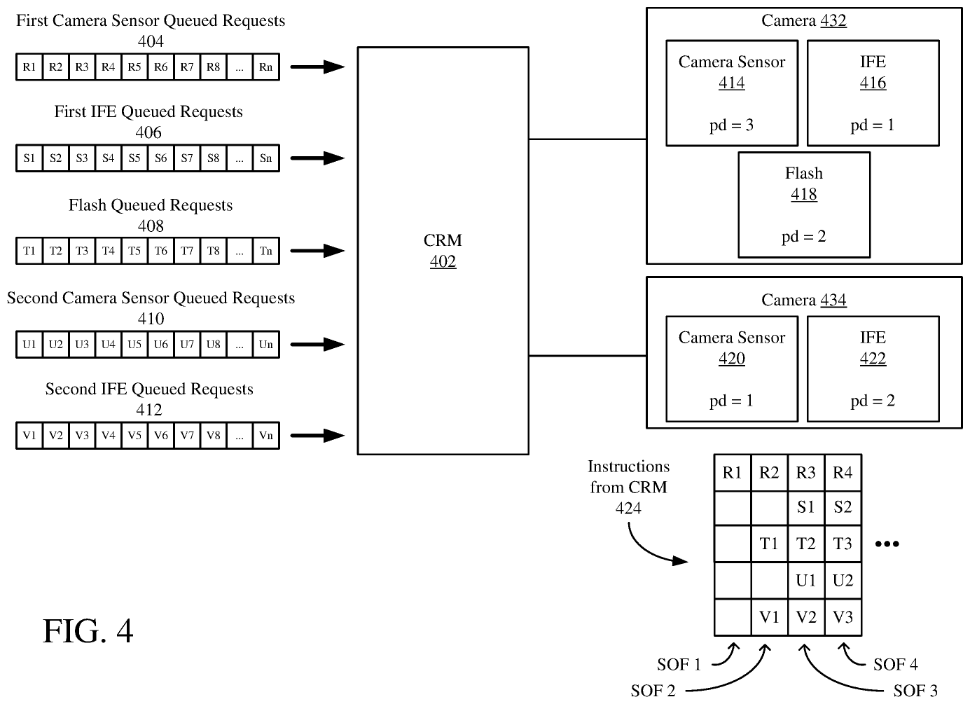

Aspects of the CRM 302 described above for a single camera may be applied for multiple cameras, such as illustrated in FIG. 4. FIG. 4 is an illustration of a CRM 402 coupled to a plurality of camera components 416-420 associated with two cameras 432 and 434. The cameras 432 and 434 may be an example implementation of the first camera 202 and the second camera 204 in FIG. 2. While two cameras are shown, any suitable number of cameras and camera components of imaging pipelines may be coupled to the CRM 402. For example, the CRM 402 may be coupled to a triple camera module or a quad camera module of a smartphone, a plurality of cameras and processing pipelines for a security system, etc. In some implementations, the camera 432 may be a primary camera and the camera 434 may be an auxiliary camera. While the flash 418 is illustrated as part of the camera 432, in some other implementations, the flash 418 may be a light source separate from the camera 432 and the camera 434. Other suitable configurations of the camera components may exist, and additional or fewer camera components may be coupled to the CRM 406. For example, at least a portion of an image signal processor may be coupled to the CRM 406.

As illustrated, the CRM 402 is coupled to the camera sensor 414, the IFE 416, and the flash 418 for the camera 432. The CRM 402 is also coupled to the camera sensor 420 and the IFE 422 for the camera 434. In the example, the first camera sensor 414 is associated with a pd of three frame periods (pd=3), the second camera sensor 420 is associated with a pd of one frame period (pd=1), the first IFE 416 is associated with a pd of one frame period (pd=1), the second IFE 422 is associated with a pd of two frame periods (pd=2), and the flash 314 is associated with a pd of two frame periods (pd=2).

The CRM 402 may be configured to receive queued requests for settings to be applied for the camera components 414-422 (such as describe above). For example, the CRM 402 may be configured to receive camera sensor queued requests 404 and 410, IFE queued requests 406 and 412, and flash queued requests 408.

In some implementations, application of settings for requests R1-Rn, application of settings for requests S1-Sn, application of settings for requests T1-Tn, application of settings for requests U1-Un, and application of settings for requests V1-Vn may be completed in the order queued or received. Furthermore, application of one or more settings for request R1 for the camera sensor 414, application of one or more settings for request Si for the IFE 416, application of one or more settings for request T1 for the flash 418, application of one or more settings for request U1 for the camera sensor 420, and application of one or more settings for request V1 for the IFE 422 are to be completed for the same frame capture (such as before a SOF of a first frame). Requests R2, S2, T2, U2, and V2 similarly may be associated with settings to be applied for a same frame capture (such as a SOF of a second frame after the first frame). Requests R3, S3, T3, U3, and V3, requests R4, S4, T4, U4 and V4, and so on may similarly be associated with settings that are to have synchronized application for one frame.

The CRM 402 may be configured to coordinate sending instructions for application of the settings for the camera components 414-422, as illustrated by the instruction sequence 424. In some implementations, the CRM 402 may be configured to send, at the SOFs for the camera streams for the cameras, instructions associated with the requests for applying settings to the components 414-422. While the instructions in the instruction sequence 424 for the requests are described as being provided each SOF, any suitable timing for providing the instructions may be used (such as a SOF every multiple of frame periods (e.g., each SOF every other frame period), at a time during the frame period other than the SOF, periodically during a frame period, etc.). In some implementations, the timing of providing instructions may differ based on the associated requests or a current operation of the device 200 (e.g., whether the device 200 is in a power save mode, a high-power mode, whether the camera application is a foreground process or a background process, etc.).

In the example, the instructions in the instruction sequence 424 are ordered so that request R1 is instructed at SOF 1, requests R2, T1, and V1 are instructed at SOF 2, requests R3, S1, T2, U1, and V2 are instructed at SOF 3, and so on. In this manner, application of settings for requests R1, S1, T1, U1, and V1 are completed by SOF 4, application of settings for requests R2, S2, T2, U2, and V2 are completed by SOF 5, and so on. As noted above, the CRM may coordinate instruction of requests for any number of camera components associated with one or more cameras.

In FIG. 4, the SOF is depicted as synchronized between the multiple cameras 432 and 434. However, in some implementations, there may exist a difference (within a tolerance) of the SOFs between different cameras' camera streams. In some implementations, the device 200 may associate frames with similar SOFs (such as SOFs within the tolerance). In this manner, aspects of the disclosure apply to synchronization of settings application to frames not aligned exactly for different camera streams. As used herein, aligned frames or aligned camera streams may refer to one or more timing aspects of frames of different camera streams that do not differ from one another by more than a tolerance or threshold. In some implementations, the SOFs for aligned frames among camera streams may all occur within a threshold amount of time of one another. In some aspects, the end of frames may differ if the camera streams have different frame rates. In some other implementations, the end of frames for aligned frames among camera streams may all occur within a threshold amount of time of one another. In this manner, the start of the next frame among the camera streams may be within a threshold amount of time of one another. In some further implementations, frames being aligned may be based on the amount of overlap of exposure windows of the frames among the camera streams. For example, if the overlap is greater than a threshold (such as a first camera stream frame's exposure window or the second camera stream frame's exposure window overlaps the other frame's exposure window by more than a threshold percentage of the window), the frames may be considered aligned. In this manner, the SOF or the end of frame between the frames may or may not be aligned.

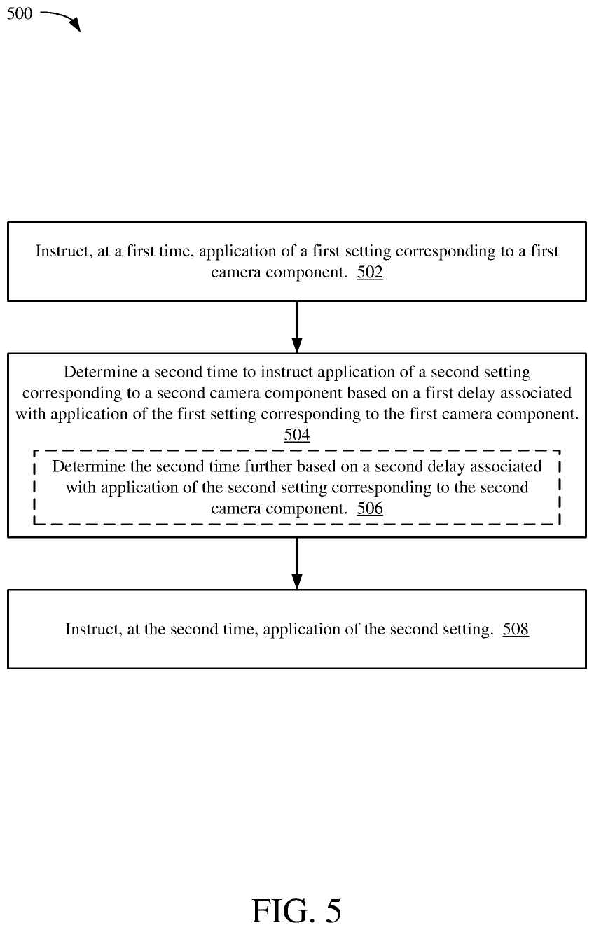

FIG. 5 is an illustrative flow chart depicting an example process 500 of coordinating instruction of requests. Blocks of the process 500 are described as being performed by the device 200, but any suitable device having any suitable configuration may be used. Additionally, the device 200 is described as including a CRM (such as CRM 306 or CRM 406), but any suitable component of the device 200 may be used.

At 502, the device 200 may instruct, at a first time, application of a first setting corresponding to a first camera component. In some implementations, a CRM may instruct application of the first setting at the first time. For example, if the first setting is an exposure setting, the CRM may provide, at the first time, an instruction to a controller of a camera sensor to cause the controller to adjust the exposure of the camera sensor. As noted above, the CRM may be implemented by one or more processors (such as the processor 206 or in the camera controller 212) or may be implemented in one or more modules coupled to the camera controller 212. In some other implementations, the processor 206 or the camera controller 212 may provide a component specific instruction to the first camera 202 for the camera sensor controller to adjust the exposure.

At 504, the device 200 may determine a second time to instruct application of a second setting corresponding to a second camera component (504). The first camera component is associated with a first delay indicating the time between instruction application of a setting for the first camera component and applying the setting for the first camera component. For example, if the first camera component is a camera sensor of the first camera 202, the first delay is a time between instructing an exposure be adjusted and completing adjustment of the exposure of the camera sensor. To synchronize application of the first setting and application of the second setting, determining the second time for instructing application of the second setting is based on the first delay. For example, the device 200 may consider the time to apply the first setting for the first camera component in determining the second time to synchronize application of the first setting and application of the second setting.

In some implementations, the second camera component may be associated with a second delay. For example, if the second camera component is an IFE of the imaging pipeline corresponding to the first camera 202, the second delay is a time between instructing the IFE to adjust a gain for converting analog data from the camera sensor and completing adjustment of the gain. The device 200 may determine the second time also based on the second delay associated with the second camera component (506). In some implementations, a CRM may determine the second time based on a difference between the first delay and the second delay. For example, if the second delay is greater than the first delay, the CRM may determine the second time to be before the first time. If the first delay is greater than the second delay, the CRM may determine the first time to be before the second time. If the delay is within a threshold amount of time (such as less than a frame period), the CRM may determine that the first time and the second time are the same time.

In some implementations, the time may refer to a specific frame of a camera stream for the corresponding camera component. For example, the CRM may determine that the instruction of applying the first setting is to occur during a first frame of a camera stream corresponding to the first camera component, and the CRM may determine that the instruction of applying the second setting is to occur during a second frame of a camera stream corresponding to the second camera component. If the first camera component and the second camera component are in the same imaging pipeline, the first camera component and the second camera component correspond to the same camera stream. If the first camera component and the second camera component are in different imaging pipelines (such as for the first camera 202 and for the second camera 204), the first camera component and the second camera component may correspond to different camera streams. As used herein, an event occurring during a frame of a camera stream (such as instructing application of a setting or completing application of the setting) refers to the event occurring when the corresponding camera is capturing the frame in the camera stream.

At 508, the device 200 may instruct, at the second time, application of the second setting. In some implementations, if the first time is during a first frame of a camera stream to be captured (such as the SOF of the first frame) and the CRM determines that the second time is during a second frame of a camera stream to be captured (based on the first delay), the CRM may instruct application of the second setting during the second frame. For example, the CRM may instruct at the SOF of the second frame.

In instructing a setting to be applied, the device 200 may provide an instruction for a camera component to apply a setting. In some implementations, the device 200 may convert a request for a specific setting to a component specific instruction, and the component specific instruction may be provided to the corresponding camera component. For example, the CRM may identify that an exposure of a camera sensor is to be adjusted. The device 200 may receive a request from a user (such as via a display 216) to adjust the exposure, the device 200 may perform an auto-exposure operation, etc., and one or more applications executed by the processor 206 may provide the request to adjust the exposure to the CRM. For example, the processor 206, executing a camera application, may generate a request to adjust the exposure of a camera sensor, and the CRM may use the request to identify that the exposure of the camera sensor is to be adjusted. Referring back to FIGS. 3 and 4, the CRM may receive a queued request R1 or U1 (such as from one or more applications executed by the processor 206). In some implementations, the CRM may convert the received request to a component specific instruction and provide the instruction to the camera sensor controller. For example, if the CRM is implemented in the camera controller 212, the camera controller 212 may provide a component specific instruction to the corresponding camera 202 or 204. In some other implementations, the CRM may be executed by a processor 206, and the processor 206 may provide, to the camera controller 212, a general instruction to adjust the exposure of the camera sensor of the first camera 202 or the second camera 204. The camera controller 212 (such as the image signal processor 214) may then convert the general instruction to a camera sensor specific instruction for the camera sensor, and the camera controller 212 may provide the component specific instruction to the corresponding camera 202 or 204.

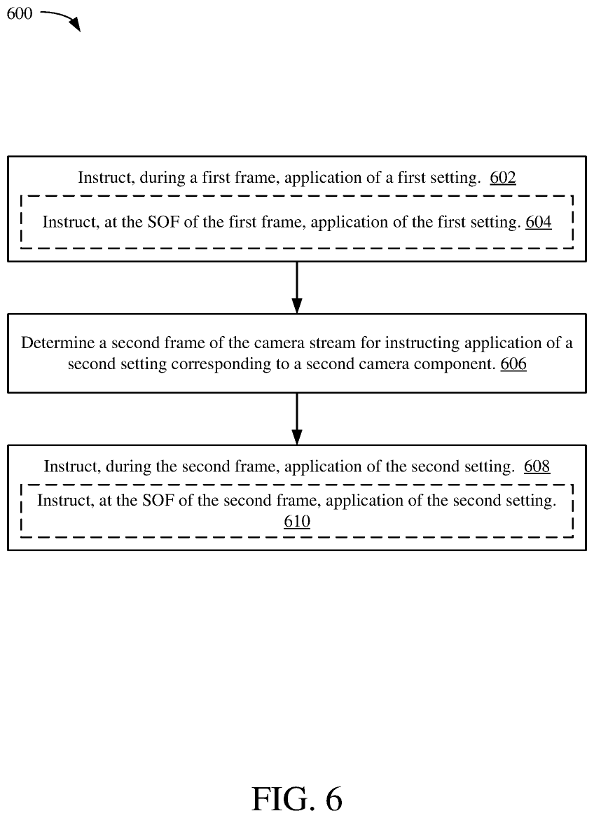

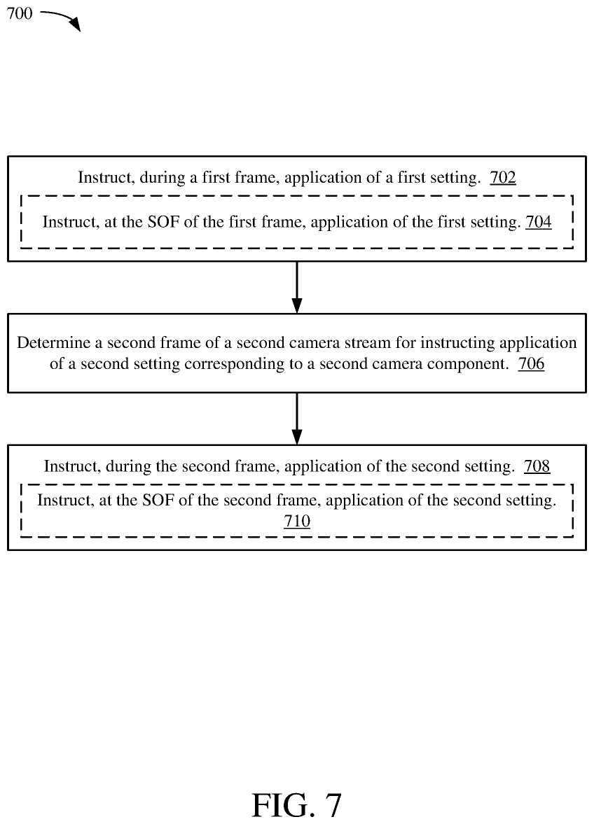

As noted above, the second camera component may be in the same imaging stream as the first camera component (thus associated with the same camera as the first camera component), or the second camera component may be in a different imaging stream than the first camera component (thus associated with a different camera than the first camera component). FIG. 6 and FIG. 7 depict example processes 600 and 700 of coordinating instruction of applying settings for camera components from the same imaging pipeline or different imaging pipelines, respectively.

FIG. 6 is an illustrative flow chart depicting an example process 600 of coordinating instruction of applying settings for multiple camera components from the same imaging pipeline. The process 600 may be an example implementation of the process 500 if the first camera component and the second camera component are from the same imaging pipeline. At 602, the device 200 may instruct, during a first frame (to be captured) of a camera stream, application of a first setting corresponding to a first camera component. For example, a CRM may provide an instruction to adjust an exposure of a camera sensor of the first camera 202 during the first frame. In some implementations, the device 200 may instruct (such as provide the instruction) at the SOF of the first frame (604). At 606, the device 200 may determine a second frame (to be captured) of the camera stream for instructing application of a second setting corresponding to a second camera component. The first camera component and the second camera component are in the same imaging pipeline (corresponding to the same camera). For example, the CRM may determine during which frame to provide an instruction to adjust a gain of an IFE to process analog data captured by the camera sensor of the first camera 202.

The device 200 may then instruct, during the second frame, application of the second setting (608). For example, the CRM may provide an instruction during the second frame for an IFE coupled to the camera sensor of the first camera 202 to adjust the gain. In some implementations, the device 200 may instruct (such as provide the instruction) at the SOF of the second frame (610). In this manner, the device 200 may synchronize application of the first setting and application of the second setting to be completed during the same frame (such as a third frame) of the camera stream, and the SOF of the subsequent frame may be associated with both settings being completed. The second frame may be before the first frame, after the first frame, or the same frame as the first frame.

FIG. 7 is an illustrative flow chart depicting an example process 700 of coordinating instruction of applying settings for multiple camera components from different imaging pipelines. The process 700 may be an example implementation of the process 500 if the first camera component and the second camera component are from different imaging pipelines. For example, a first camera component may correspond to the first camera 202 (such as a first camera sensor, IFE for the first camera 202, ISP filters specific to the first camera 202, etc.), and the second camera component may correspond to the second camera 204 (such as a second camera sensor, IFE for the second camera 204, ISP filters specific to the first camera 204, etc.).

At 702, the device 200 may instruct, during a first frame of a first camera stream, application of a first setting. For example, the CRM may provide an instruction during the first frame for a camera sensor controller of the first camera 202 to adjust the exposure. In some implementations, the device 200 may instruct (such as provide the instruction) at the SOF of the first frame (704). At 706, the device 200 may determine a second frame (to be captured) of a second camera stream for instructing application of a second setting corresponding to a second camera component. The first camera component and the second camera component are in different imaging pipelines (corresponding to different cameras). For example, the CRM may determine during which frame to provide an instruction to adjust an exposure of a camera sensor of the second camera 204 or an instruction to adjust a gain of an IFE to process analog data captured by the camera sensor of the second camera 204.

The first camera stream and the second camera stream may be aligned. For example, pairs of frames from the first camera stream and the second camera stream may be aligned with each other, and the SOF of the frame from the first camera stream is within a threshold amount of time of the SOF of the frame from the second camera stream. In this manner, the device 200 may be configured to synchronize application of settings for camera components from different imaging streams. As noted above, the second frame may be before the first frame or after the first frame. In some instances, the first frame and the second frame may overlap or otherwise occur at approximately the same time.

At 708, the device 200 may instruct, during the second frame of the second camera stream, application of the second setting. For example, the CRM may provide an instruction during the second frame for a camera sensor controller of the second camera 204 to adjust the exposure or may provide an instruction for an IFE coupled to the camera sensor of the second camera 204 to adjust the gain. In some implementations, the device 200 may instruct (such as provide the instruction) at the SOF of the second frame (710). In this manner, the device 200 may synchronize application of the first setting and application of the second setting. For example, application of the first setting may be completed during a third frame of the first camera stream, and application of the second setting may be completed during a fourth frame of the second camera stream (with the third camera frame and the fourth camera frame being aligned). In this manner, the SOF of the subsequent frame of each camera stream is associated with both settings being completed.

While the flowcharts and illustrated examples describe two camera components and two settings, any number of camera components and settings may be managed in the same manner. For example, the device 200 may be configured to instruct application of a first setting at a first time, determine a second time for instructing application of a second setting, determine a third time for instructing application of a third setting, and so on. In some implementations, the first setting may be associated with a first camera stream, the second setting may be associated with a second camera stream, and the third setting may be associated with a third camera stream (such as if the device 200 is coupled to three or more cameras). In some other implementations, multiple settings may be associated with the same camera stream. The examples and flowcharts are provided for illustrative purposes, and the present disclosure is not limited to a specific number of camera components, imaging pipelines, settings, etc.

Errors may occur in applying one or more settings. For example, an error may occur in the first camera 202 adjusting an exposure of the camera sensor (such as a result of loss of power to the first camera 202, the instruction not being received by the first camera 202, the instruction not being implemented in a time indicated by the pd for the camera component, and so on). The device 200 may be notified when an error occurs. For example, the first camera 202 may generate a signal that the exposure is not adjusted. The CRM may receive an error notification and may again instruct application of the setting. If settings are to be applied in a sequence or order, the CRM may be configured to determine new settings starting at the setting not applied or causing the error. The CRM may be configured to time instructing the new settings be applied to continue synchronizing application of the settings. In some implementations, if the settings being applied are for camera components from a single imaging pipeline, the device 200 may repeat the instructions (and timing of instructions) beginning at the instruction for which the error occurred.

In some implementations where settings are for camera components of different imaging pipelines (such as illustrated in FIG. 4), after instruction by the CRM 402, the CRM 402 may receive confirmation that a setting is adjusted or may receive an error indication that the setting could not be adjusted (such as not be adjusted in the time indicated by the pd for the camera component). For example, adjusting a gain setting based on the request V2 for the second IFE 422 may not be completed by the same SOF as for the gain setting based on the request S2 for the first IFE 416. The CRM 402 may receive an error indication from, e.g., the camera controller 212 or the second camera 204, for the request V2. The CRM 402 may also determine an error based on abnormal operation of the device 200 or one or more cameras, not receiving confirmation that a setting is applied, not receiving a request to be instructed at a specific time, or other suitable factors indicating an error has occurred. Errors may be caused by, for example, irregular camera sensor behavior in causing delayed or missing SOFs, frame delays in transitioning between settings, and so on.

The device 200 (such as the CRM 402) may be configured to handle errors to maintain synchronization of the application of settings. In this manner, the CRM 402 may coordinate the settings continuing to be applied in the requested sequence and during the requested frame (such as by a requested SOF or other suitable time). In some example implementations, the CRM 402 may cause settings to be redetermined and re-requested for existing requests corresponding and subsequent to the request for which an error occurred.

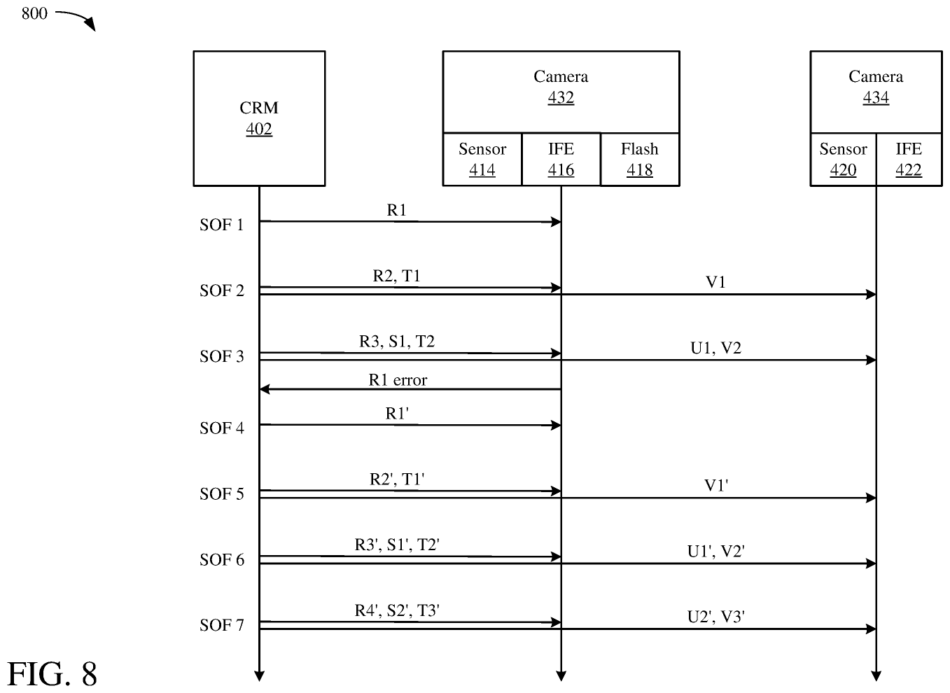

FIG. 8 is an illustration of an example timing diagram 800 for error handling. The device 200 may determine the settings and queue the requests for the determined settings, and the CRM 402 may instruct the requests to the respective camera components so that the device 200 may capture an image using the camera 432 (such as the first camera 202) and the camera 434 (such as the second camera 204) with the determined settings applied. In the example, the instructions of the instruction sequence 424 (FIG. 4) are provided by the CRM 402 for the cameras 432 and 434. At SOF 1, the CRM 402 instructs application of a setting for request R1 for the camera sensor 414 of the camera 432. At SOF 2, the CRM 402 instructs application of a setting for request R2 for the camera sensor 414 of the camera 432, application of a setting for request T1 for the flash 418, and application of a setting for request V1 for the IFE 422 corresponding to the camera 434. At SOF 3, the CRM 402 instructs application of a setting for request R3 for the camera sensor 414 of the camera 432, application of a setting for request Si for the IFE 416 corresponding to the camera 432, application of a setting for request T2 for the flash 418, application of a setting for request U1 for the camera sensor 420 of the camera 434, and application of a setting for request V2 for the IFE 422 corresponding to the camera 434.

With the camera sensor 414 corresponding to a pd equal to 3, application of the setting for request R1 instructed at SOF 1 would be completed by SOF 4. However, in the example, the CRM 402 receives an error indication before SOF 4 that the setting cannot be applied for request R1. In some other implementations, the CRM 402 may receive confirmation for each request being completed, and the CRM 402 may not receive confirmation that the request R1 is complete within a defined amount of time to indicate an error. In some further implementations, the CRM 402 may determine that the error occurred by other suitable means (such as by observing operation of the device 200 and determining through the observation that a setting is not applied). For example, an image signal processor 214 may determine that the luminance in the camera stream does not change after the exposure of the camera sensor should have been adjusted. In this manner, the device 200 may determine that an error occurred in applying an exposure setting associated with a camera sensor request.

In one example, settings associated with requests R1, S1, T1, U1, and V1 may include a first exposure setting for the first camera sensor 414, a first gain setting for the first IFE 416, a flash intensity and duration for the flash 418, a first exposure setting for the second camera sensor 420, and a second gain setting for the second IFE 422, respectively. If an error occurs (such as for request R1), application of the settings are not synchronized, and an image may not be captured with the determined settings applied for the camera components. For example, the determined first exposure setting (corresponding to the request R1) may not be applied for the first camera sensor 414 for the image capture, and an error occurs for the request R1.

In some implementations, the CRM 402 may perform error handling by causing the device 200 to determine new settings in response to an error. For example, the CRM 402 receives an error for request R1, and in response instructs for the camera components the device 200 to determine new exposure settings, gain settings, and a flash setting to be applied to the camera components. The new settings may be indicated by new requests R1′, S1′, T1′, U1′, and V1′, for which application of the new settings are instructed by the CRM 402 at SOFs 4-6. In the example, the device 200 may also determine new settings for the subsequent requests (such as requests R2′, R3′, R4′, S2′, T2′, T3′, U2′, V2′, and V3′ shown as having application of settings instructed by the CRM 402 at SOFs 5-7). In this manner, the CRM 402 may maintain synchronization of settings being applied, including when and after an error occurs. As a result, the settings are not misaligned for the frames to be used from the camera stream of the first camera 202 and the camera stream of the second camera 204 for imaging or video.

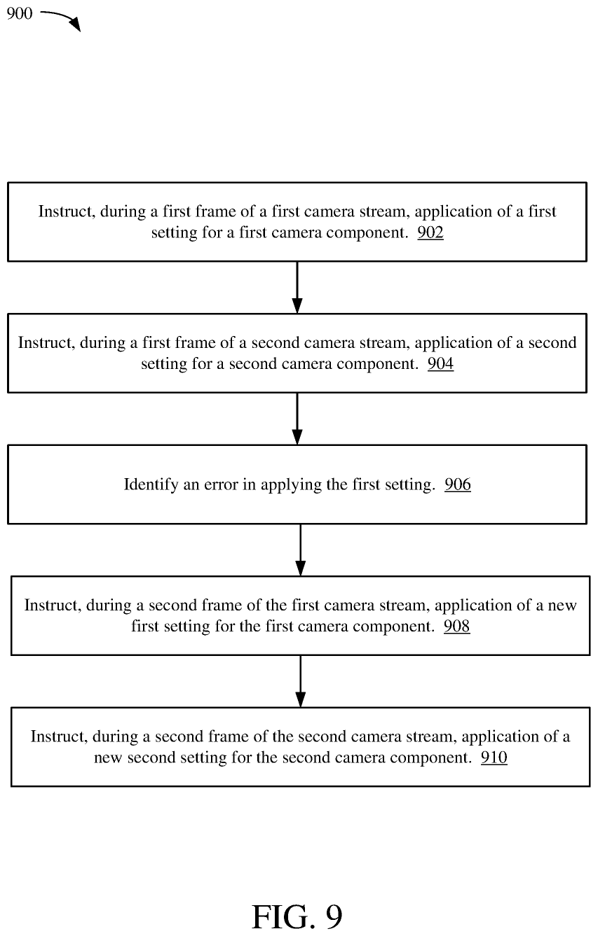

FIG. 9 is an illustrative flow chart depicting an example operation 900 of error handling in coordinating instruction of applying settings for multiple camera components in different imaging pipelines. At 902, the device 200 may instruct, during a first frame of a first camera stream, application of a first setting for a first camera component from a first imaging pipeline. The device 200 may also instruct, during a first frame of a second camera stream, application of a second setting for a second camera component of a second imaging pipeline (904). The difference in time between the first frame of the second camera stream and the first frame of the first camera stream may be based on a first delay associated with the first camera component and a second delay associated with the second camera component. For example, the timing between the first frame of the first camera stream and the first frame of the second camera stream may be based on a difference between the first delay and the second delay (to synchronize application of the first setting and application of the second setting).

There may be an error in applying the first setting. After instructing application of the first setting, the device 200 may identify an error in applying the first setting (906). The device 200 (such as a CRM) may instruct application of the second setting before identifying an error in applying the first setting. In some implementations, the CRM may receive an error indication from the camera controller 212, the associated camera component, or another suitable component or module of the device 200 indicating the error. In some other implementations, the CRM may not receive an indication that the first setting is applied within a defined amount of time (such as based on the first delay). In response, the device 200 may determine a new first setting and a new second setting. For example, if the first setting is an exposure setting for the first camera 202 and the second setting is an exposure setting for the second camera 204, the device 200 may determine new exposure settings to be applied for the first camera 202 and the second camera 204.

The device 200 (such as the CRM) may instruct, during a second frame (to be captured) of the first camera stream, application of the new first setting (908). The device 200 may also instruct, during a second frame (to be captured) of the second camera stream, application of the new second setting (910). Similar to the first camera frames between the first camera stream and the second camera stream, the timing between the second frame of the first camera stream and the second frame of the second camera stream may be based on a difference between the first delay and the second delay (to synchronize application of the new first setting and application of the new second setting). In this manner, the device 200 may ensure settings are synchronized even when an error occurs in applying one or more setting.

As described above, the device 200 (or other suitable device) is configured to coordinate instruction of applying settings to camera components to ensure the application of such settings is synchronized. In this manner, the settings are not misaligned for image capture. As noted above, the techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium (such as the memory 208 in the example device 200) comprising instructions 210 that, when executed by the processor 206 (or the image signal processor 214), cause the device 200 to perform one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors, such as the processor 206 or the image signal processor 214 in the example device 200. Such processor(s) may include but are not limited to one or more digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

While the present disclosure shows illustrative aspects, it should be noted that various changes and modifications could be made herein without departing from the scope of the appended claims. For example, while a single or two cameras are illustrated, a device may include any suitable number of cameras. Furthermore, any suitable camera components may be used and are not limited to the example components. In another example, while instructions by the CRM are described as being provided at SOFs, instructions may be provided at any suitable time. Additionally, the functions, steps or actions of the method claims in accordance with aspects described herein need not be performed in any particular order unless expressly stated otherwise. For example, the steps of the example operations illustrated in FIGS. 5, 6, 7, and 9 may be performed in any suitable order and frequency. Furthermore, although elements may be described or claimed in the singular, the plural is contemplated unless limitation to the singular is explicitly stated. Accordingly, the disclosure is not limited to the illustrated examples and any means for performing the functionality described herein are included in aspects of the disclosure.

What is claimed is:

1. A device configured to synchronize application of settings for different camera components, comprising:
a memory, and
one or more processors coupled to the memory, the one or more processors configured to:
instruct, at a first time, application of a first setting corresponding to a first camera component, wherein application of the first setting is associated with a first delay;
determine, based on the first delay, a second time to instruct application of a second setting corresponding to a second camera component; and
instruct, at the second time, application of the second setting, wherein application of the first setting and application of the second setting are synchronized based on the first time and the second time.

2. The device of claim 1, wherein the one or more processors are further configured to determine the second time further based on a second delay associated with application of the second setting.

3. The device of claim 2, wherein the one or more processors are further configured to:
convert a first request to apply the first setting to the first camera component into a first component specific instruction, wherein:
the first request is from one or more applications executed by the one or more processors; and
the one or more processors are configured to provide the first component specific instruction in instructing application of the first setting; and
convert a second request to apply the second setting to the second camera component into a second component specific instruction, wherein:
the second request is from one or more applications executed by the one or more processors; and
the one or more processors are configured to provide the second component specific instruction in instructing application of the second setting.

4. The device of claim 3, wherein the one or more processors are further configured to:
instruct application of the first setting during a first frame of a camera stream; and
instruct application of the second setting during a second frame of the camera stream, wherein:
the first camera component and the second camera component are in an imaging pipeline corresponding to a camera configured to capture the camera stream; and
application of the first setting and application of the second setting being synchronized includes application of the first setting being completed and application of the second setting being completed during a third frame of the camera stream.

5. The device of claim 4, wherein the one or more processors are further configured to:
instruct application of the first setting at a start of frame (SOF) of the first frame; and
instruct application of the second setting at a SOF of the second frame.

6. The device of claim 4, further comprising:
the first camera component;
the second camera component; and
the camera.

7. The device of claim 6, wherein the first camera component and the second camera component include at least one from the group consisting of:
a camera sensor of the camera configured to capture analog data representing the camera stream;
an imaging front end configured to convert the analog data to the camera stream in a digital representation;
a flash of the device; and
an image signal processor configured to process the camera stream from the imaging front end.

8. The device of claim 3, wherein the one or more processors are further configured to:
instruct application of the first setting during a first frame of a first camera stream; and
instruct application of the second setting during a second frame of a second camera stream, wherein:
the first camera component is in a first imaging pipeline corresponding to a first camera configured to capture the first camera stream;
the second camera component is in a second imaging pipeline corresponding to a second camera configured to capture the second camera stream; and
application of the first setting and application of the second setting being synchronized includes:
application of the first setting being completed during a third frame of the first camera stream; and
application of the second setting being completed during a fourth frame of the second camera stream, wherein the third frame and the fourth frame are aligned.

9. The device of claim 8, wherein the one or more processors are further configured to:
instruct application of the first setting at a start of frame (SOF) of the first frame; and
instruct application of the second setting at a SOF of the second frame.

10. The device of claim 8, wherein the one or more processors are further configured to:
identify an error in applying the first setting after instructing application of the first setting; and
in response to identifying the error:
instruct, during a fifth frame of the first camera stream, application of a new first setting corresponding to the first camera component; and
instruct, during a sixth frame of the second camera stream, application of a new second setting corresponding to the second camera component, wherein the sixth frame is based on the first delay and the second delay.

11. The device of claim 8, further comprising:
the first camera component;
the second camera component;
wherein the first camera component and the second camera component include at least one from the group consisting of:
a first camera sensor of the first camera configured to capture a first analog data representing the first camera stream;
a second camera sensor of the second camera configured to capture a second analog data representing the second camera stream;
an imaging front end configured to perform at least one from the group consisting of:
converting the first analog data to the first camera stream in a digital representation; and
converting the second analog data to the second camera stream in a digital representation;
a flash of the device; and
an image signal processor configured to perform at least one from the group consisting of:
processing the first camera stream from the imaging front end; and
processing the second camera stream from the imaging front end.

12. The device of claim 8, wherein the one or more processors are further configured to:
determine a fifth frame of a third camera stream during which to instruct application of a third setting corresponding to a third camera component of a third imaging pipeline, wherein the fifth frame is based on one or more of the first delay or the second delay;
instruct, during the fifth frame, application of the third setting, wherein:
application of the third setting is completed during a sixth frame of the third camera stream; and
the sixth frame is aligned with the third frame and the fourth frame.

13. A method of synchronizing application of settings for different camera components, comprising:
instructing, at a first time, application of a first setting corresponding to a first camera component, wherein application of the first setting is associated with a first delay;
determining, based on the first delay, a second time to instruct application of a second setting corresponding to a second camera component; and
instructing, at the second time, application of the second setting, wherein application of the first setting and application of the second setting are synchronized based on the first time and the second time.

14. The method of claim 13, wherein determining the second time is further based on a second delay associated with application of the second setting.

15. The method of claim 14, further comprising:
converting a first request to apply the first setting to the first camera component into a first component specific instruction, wherein instructing application of the first setting includes providing the first component specific instruction; and
converting a second request to apply the second setting to the second camera component into a second component specific instruction, wherein instructing application of the second setting includes providing the second component specific instruction.

16. The method of claim 15, further comprising:
instructing application of the first setting during a first frame of a camera stream; and
instructing application of the second setting during a second frame of the camera stream, wherein:
the first camera component and the second camera component are in an imaging pipeline corresponding to a camera configured to capture the camera stream; and
application of the first setting and application of the second setting being synchronized includes application of the first setting being completed and application of the second setting being completed during a third frame of the camera stream.

17. The method of claim 16, further comprising:
instructing application of the first setting at a start of frame (SOF) of the first frame; and
instructing application of the second setting at a SOF of the second frame.

18. The method of claim 15, further comprising:
instructing application of the first setting during a first frame of a first camera stream; and
instructing application of the second setting during a second frame of a second camera stream, wherein:
the first camera component is in a first imaging pipeline corresponding to a first camera configured to capture the first camera stream;
the second camera component is in a second imaging pipeline corresponding to a second camera configured to capture the second camera stream; and
application of the first setting and application of the second setting being synchronized includes:
application of the first setting being completed during a third frame of the first camera stream; and
application of the second setting being completed during a fourth frame of the second camera stream, wherein the third frame and the fourth frame are aligned.

19. The method of claim 18, further comprising:
instructing application of the first setting at a start of frame (SOF) of the first frame; and
instructing application of the second setting at a SOF of the second frame.

20. The method of claim 18, further comprising:
identifying an error in applying the first setting after instructing application of the first setting; and
in response to identifying the error:
instructing, during a fifth frame of the first camera stream, application of a new first setting corresponding to the first camera component; and
instructing, during a sixth frame of the second camera stream, application of a new second setting corresponding to the second camera component, wherein the sixth frame is based on the first delay and the second delay.

21. A non-transitory, computer readable medium storing instructions that, when executed by one or more processors of a device, cause the device to:
instruct, at a first time, application of a first setting corresponding to a first camera component, wherein application of the first setting is associated with a first delay;
determine, based on the first delay, a second time to instruct application of a second setting corresponding to a second camera component; and
instruct, at the second time, application of the second setting, wherein application of the first setting and application of the second setting are synchronized based on the first time and the second time.

22. The computer readable medium of claim 21, wherein the second time is further based on a second delay associated with application of the second setting.

23. The computer readable medium of claim 22, wherein execution of the instructions further causes the device to:
convert a first request to apply the first setting to the first camera component into a first component specific instruction, wherein instructing application of the first setting includes providing the first component specific instruction; and
convert a second request to apply the second setting to the second camera component into a second component specific instruction, wherein instructing application of the second setting includes providing the second component specific instruction.

24. The computer readable medium of claim 23, wherein execution of the instructions further causes the device to:
instruct application of the first setting during a first frame of a camera stream; and
instruct application of the second setting during a second frame of the camera stream, wherein:
the first camera component and the second camera component are in an imaging pipeline corresponding to a camera configured to capture the camera stream; and
application of the first setting and application of the second setting being synchronized includes application of the first setting being completed and application of the second setting being completed during a third frame of the camera stream.

25. The computer readable medium of claim 24, wherein execution of the instructions further causes the device to:
instruct application of the first setting at a start of frame (SOF) of the first frame; and
instruct application of the second setting at a SOF of the second frame.

26. The computer readable medium of claim 24, wherein execution of the instructions further causes the device to:
instruct application of the first setting during a first frame of a first camera stream; and
instruct application of the second setting during a second frame of a second camera stream, wherein:
the first camera component is in a first imaging pipeline corresponding to a first camera configured to capture the first camera stream;
the second camera component is in a second imaging pipeline corresponding to a second camera configured to capture the second camera stream; and
application of the first setting and application of the second setting being synchronized includes:
application of the first setting being completed during a third frame of the first camera stream; and
application of the second setting being completed during a fourth frame of the second camera stream, wherein the third frame and the fourth frame are aligned.

27. The computer readable medium of claim 26, wherein execution of the instructions further causes the device to:
instruct application of the first setting at a start of frame (SOF) of the first frame; and
instruct application of the second setting at a SOF of the second frame.

28. The computer readable medium of claim 26, wherein execution of the instructions further causes the device to:
identify an error in applying the first setting after instructing application of the first setting; and
in response to identifying the error:
instruct, during a fifth frame of the first camera stream, application of a new first setting corresponding to the first camera component; and
instruct, during a sixth frame of the second camera stream, application of a new second setting corresponding to the second camera component, wherein the sixth frame is based on the first delay and the second delay.

29. A device configured to synchronize application of settings for different camera components, comprising:
means for instructing, at a first time, application of a first setting corresponding to a first camera component, wherein application of the first setting is associated with a first delay;
means for determining a second time to instruct application of a second setting corresponding to a second camera component, wherein:
application of the second setting is associated with a second delay; and
the second time is based on the first delay and the second delay; and
means for instructing, at the second time, application of the second setting, wherein application of the first setting and application of the second setting are synchronized based on the first time and the second time.

30. The device of claim 29, further comprising:
means for instructing application of the first setting during a first frame of a first camera stream;
means for instructing application of the second setting during a second frame of a second camera stream, wherein:
the first camera component is in a first imaging pipeline corresponding to a first camera configured to capture the first camera stream;
the second camera component is in a second imaging pipeline corresponding to a second camera configured to capture the second camera stream; and
application of the first setting and application of the second setting being synchronized includes:
application of the first setting being completed during a third frame of the first camera stream; and
application of the second setting being completed during a fourth frame of the second camera stream, wherein the third frame and the fourth frame are aligned.
